(19) United States
(12) Patent Application Publication
(10) Pub. No.: US 2006/0280533 A1
(43) Pub. Date: Dec. 14, 2006

(54) Image forming apparatus

(75) Inventor: Toru Ozawa, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/293,235

(22) Filed: Dec. 5, 2005

(30) Foreign Application Priority Data
Jun. 13, 2005 (JP) 2005-172525

(51) Int. Cl. G03G 15/00

(52) U.S. Cl. 399/361

(57) ABSTRACT

An image forming apparatus includes: an apparatus body; an image forming section disposed in the apparatus body; a conveyor belt that forms a first conveyance path between itself and the image forming section; a cover that is axially supported by a support shaft such that the cover is pivotable with respect to the apparatus body; and a conveyor belt unit that includes the conveyor belt, is axially supported such that it is pivotable with respect to the cover, and forms between itself and the cover a second conveyance path that returns the recording medium to the first conveyance path. The first conveyance path can be opened up by pivoting the cover, with the conveyor belt unit being integrally pivoted with the cover, and the second conveyance path can be opened up by pivoting the conveyor belt unit in a state where the first conveyance path has been opened up.

### CROSS-REFERENCE TO RELATED APPLICATION

This application claims priority under 35 USC 119 from Japanese Patent Application No. 2005-172525, the disclosure of which is incorporated by reference herein.

### BACKGROUND OF THE INVENTION

1. Field of the Invention

The present invention relates to an image forming apparatus that forms an image on a recording medium.

2. Description of the Related Art

As image forming apparatus that form an image on a recording medium, image forming apparatus have conventionally been known where a recording medium, on which an image is to be formed, is conveyed by a conveyor belt that forms a first conveyance path between itself and an image forming section disposed in the apparatus body. When an image has been formed on one side of the recording medium, the recording medium is returned to the first conveyance path by a second conveyance path disposed facing the first conveyance path, with the conveyor belt sandwiched therebetween, such that an image is formed on the other side of the recording medium.

Japanese Patent Application Publication (JP-A) No. 2003-316107 discloses such an image forming apparatus where a cover including a support point below is pivoted integrally with the conveyor belt to open up the first conveyance path in order to remove a recording medium that has become jammed in the first conveyance path.

However, in the image forming apparatus of JP-A No. 2003-316107, when a recording medium has become jammed in the second conveyance path, it is difficult to remove the jammed recording medium because the second conveyance path is not opened up.

JP-A No. 2003-241466 discloses an image forming apparatus where, when the first conveyance path is to be opened up, an upper cover including a support point above is pivoted, and then a handle disposed on the conveyor belt is pulled, whereby the conveyor belt and a lower cover including a support point below are integrally pivoted so that the first conveyance path is opened. When the second conveyance path is to be opened up, the upper cover is pivoted, and then only the lower cover is pivoted so that the second conveyance path is opened up.

However, in the image forming apparatus of JP-A No. 2003-241466, the conveyor belt and the lower cover are integrally pivoted by pulling the handle disposed on the conveyor belt. For that reason, it is necessary to open the upper cover in order to ensure that the handle of the conveyor belt can be gripped, and the two actions of pivoting the upper cover and pivoting the conveyor belt and the lower cover become necessary in order to open up the first conveyance path.

For this reason, the access to the first conveyance path, which is opened up frequently, is poor and the operation is complicated.

### SUMMARY OF THE INVENTION

In view of the above circumstances, the present invention provides an image forming apparatus where the operability of opening up the conveyance paths is good.

A first aspect of the invention provides an image forming apparatus that forms an image on a recording medium, the image forming apparatus including: an apparatus body; an image forming section disposed in the apparatus body; a conveyor belt that forms a first conveyance path between itself and the image forming section; a cover that is axially supported by a support shaft such that the cover is pivotable with respect to the apparatus body; and a conveyor belt unit that includes the conveyor belt, is axially supported such that the conveyor belt unit is pivotable with respect to the cover, and forms between itself and the cover a second conveyance path that returns the recording medium to the first conveyance path, wherein the first conveyance path can be opened up by pivoting the cover, with the conveyor belt unit being integrally pivoted with the cover, and the second conveyance path can be opened up by pivoting the conveyor belt unit in a state where the first conveyance path has been opened up.

In this configuration, the conveyor belt unit that includes the conveyor belt and forms between itself and the cover a second conveyance path that returns the recording medium to the first conveyance path is axially supported on the cover and not on the apparatus body.

Thus, by pivoting the cover, the conveyor belt unit pivots integrally with the cover such that the first conveyance path can be opened up. Also, by pivoting the conveyor belt unit with respect to the cover, the second conveyance path can be opened up.

In this manner, the first conveyance path can be opened up with the single action of pivoting the cover.

The recording medium, on which an image is to be formed, is conveyed on the first conveyance path. Thus, the potential for the recording medium to become jammed in the first conveyance path is high because the first conveyance path has a higher frequency of use than that of the second conveyance path for returning the recording medium to the first conveyance path. However, in the present configuration, because the first conveyance path can be opened up with a single action, its operability is good and it is easy to access.

Also, because the second conveyance path can be opened up by pivoting the conveyor belt unit, its operability is good.

### BRIEF DESCRIPTION OF THE DRAWINGS

An embodiment of the present invention will be described in detail based on the following figures, wherein:

FIG. 1 is a side view of an image forming apparatus pertaining to the embodiment of the invention;

FIG. 2 is a side view of the image forming apparatus in a state where a cover pertaining to the embodiment is opened;

FIG. 3 is a perspective view of the image forming apparatus in a state where the cover pertaining to the embodiment is opened; and

FIG. 4 is a diagram showing a release button (release portion) pertaining to the embodiment.

### DETAILED DESCRIPTION OF THE INVENTION

An example of an embodiment pertaining to the image forming apparatus of the invention will be described below on the basis of the drawings.

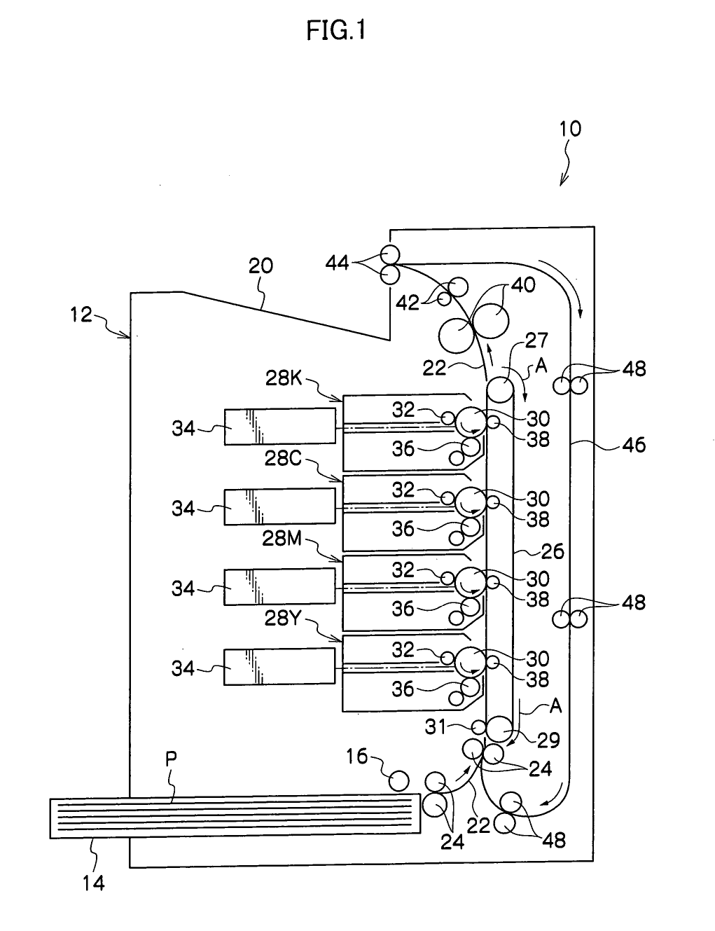

First, the overall configuration of an image forming apparatus 10 of the present embodiment will be described on the basis of FIG. 1.

As shown in FIG. 1, the image forming apparatus 10 of the present embodiment includes an apparatus body 12. A paper supply tray 14, in which paper (a recording medium) P is stacked and accommodated, is disposed in the lower portion of the apparatus body 12. The right side in FIG. 1 corresponds to the front surface side of the image forming apparatus 10, and the left side in FIG. 1 corresponds to the rear surface side of the image forming apparatus 10.

A feed roll 16 that contacts the leading end portion of the upper surface of the paper P and removes the paper P from the paper supply tray 14 is disposed on the upper portion of the front end side (right end side in FIG. 1) of the paper supply tray 14.

The image forming apparatus 10 includes first conveyance path 22 that extends from the front end portion of the paper supply tray 14, curves gently, and extends substantially vertically upward at the apparatus front surface side (right side in FIG. 1).

Plural (e.g., two) conveyance roll pairs 24, which nip and convey the paper P, and an endless conveyor belt 26, which electrostatically sucks and conveys the paper P on which an image is to be formed, are disposed in order from the upstream side in the paper conveyance direction along the first conveyance path 22. Because the conveyor belt 26 is disposed along the first conveyance path 22, the conveyor belt 26 forms part of the path surface of one side of the first conveyance path 22.

The conveyor belt 26 is stretched across a stretch roller 27 disposed above and a stretch roller 29 disposed below. One of the stretch roller 27 and the stretch roller 29 is rotatingly driven, whereby the conveyor belt 26 rotates in the direction of arrow A.

A charge roll 31, which charges the surface of the conveyor belt 26 and pushes the paper P to be electrostatically suctioned onto the conveyor belt 26 against the conveyor belt 26, is disposed adjacent to the conveyor belt 26 upstream of the conveyor belt 26 in the conveyance direction.

Plural process cartridges 28Y, 28M, 28C and 28K corresponding to the respective colors of yellow, magenta, cyan and black are disposed in a column in the substantially vertical direction in the apparatus body 12 in the horizontal direction facing the conveyor belt 26, with the first conveyance path 22 sandwiched between the process cartridges 28 and the conveyor belt 26.

Each of the process cartridge 28Y, 28M, 28C and 28K includes a photosensitive drum (image forming section) 30 that rotates in a predetermined direction (counter-clockwise direction in FIG. 1).

Disposed around the photosensitive drums 30 and in order from the rotational-direction upstream side of the photosensitive drum 30 around each photosensitive drum 30 are charge rollers 32 that charge the surfaces of the photosensitive drums 30, exposure devices 34 that expose the photosensitive drums 30 to light to form latent images on the photosensitive drums 30, and development rollers 36 that adhere, and develop, toners of the respective colors to the latent images formed on the photosensitive drums 30.

Transfer devices 38, which transfer the toner images formed on the photosensitive drums 30 to the paper P at predetermined transfer positions, are disposed at the inner circumferential side of the conveyor belt 26 in the horizontal direction facing the photosensitive drums 30, with the conveyor belt 26 sandwiched between the transfer devices 38 and the photosensitive drums 30.

A fixing device 40 that fixes the transferred toner images to the paper P, a conveyance roll pair 42 that nips and conveys the paper P, and a discharge roll pair 44 that discharges the paper P to a discharge tray 20 are disposed downstream of the conveyor belt 26 in the conveyance direction.

A second conveyance path 46, for inverting the paper P on which an image has been formed on one side and returning the paper P again to the first conveyance path 22, is disposed facing the first conveyance path 22 with the conveyor belt 26 sandwiched therebetween.

Plural (e.g., three) conveyance roll pairs 48 that nip and convey the paper P downward are disposed in the second conveyance path 46. When an image is to be formed on both sides of the paper P, the paper P on which an image has been formed on one side is switched back by the discharge roll pair 44, guided to the second conveyance path 46, conveyed downward by the plural conveyance roll pairs 48, and returned to the first conveyance path 22.

Next, the operation of forming an image in the image forming apparatus 10 of the present embodiment will be described.

In the image forming apparatus 10 of the present embodiment, when an image is to be formed on one side of the recording paper P, the paper P is removed from the paper supply tray 14, conveyed upward along the conveyance path 22 by the plural conveyance roll pairs 24, and fed to the conveyor belt 26. The paper P fed to the conveyor belt 26 is pushed against the conveyor belt 26 by the charge roll 31, electrostatically suctioned to the charged conveyor belt 26, conveyed upward, and sequentially fed to the predetermined transfer positions corresponding to the respective colors of yellow, magenta, cyan and black.

Toner images of the respective colors formed on the photosensitive drums 30 are transferred by the transfer devices 38 to the paper P fed to the predetermined transfer positions, and a full-color image is formed. The paper P is then conveyed to the fixing device 40, where the transferred toner images are fixed to the paper P, and then the paper P is discharged to the discharge tray 20 by the discharge roll pair 44.

When an image is to be formed on both sides of the paper P, the toner images are fixed to the paper P by the fixing device 40 to form an image on one side of the paper P. Then, the paper P, on which an image has been formed on one side, is switched back by the discharge roll pair 44, inverted, and fed to the second conveyance path 46. The paper P is fed from the second conveyance path 46 again to the first conveyance path 22 and an image is formed on the other side of the paper P in the same manner as described above, whereby images are formed on both sides of the paper P. In this manner, a series of image forming operations is conducted.

Next, a configuration that opens up the first conveyance path 22 and the second conveyance path 46 will be described.

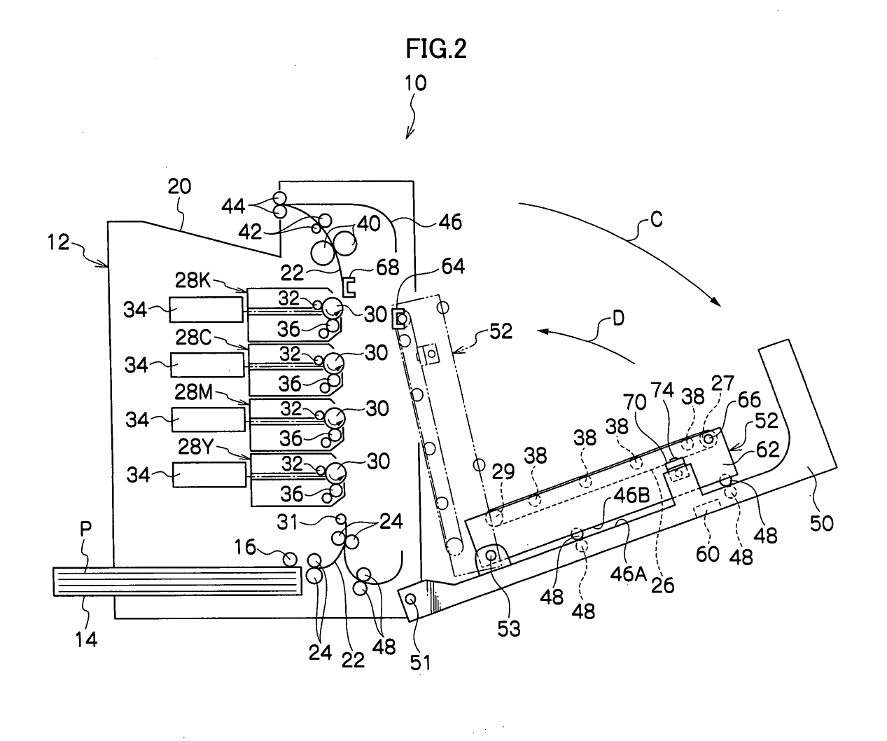

As shown in FIG. 2, an L-shaped cover 50 is disposed in the image forming apparatus 10. The cover 50 is pivotably axially supported by a support shaft 51 in the lower portion of the apparatus body 12. The cover 50 is configured to open up the first conveyance path 22 as a result of being pivoted outward and reclined from the apparatus body 12 (in the direction of arrow C in FIG. 2).

One path surface 46A of the second conveyance path 46 is formed, and one roll of each of the two upper conveyance roll pairs 48 is disposed, at the inner surface side of the cover 50. A handle 60 that is gripped when causing the cover 50 to pivot is disposed in the outer surface of the cover 50.

The image forming apparatus 10 includes a conveyor belt unit 52 that is pivotably axially supported by a support shaft 53 in the lower portion of the cover 50 and configured to open up the second conveyance path 46 as a result of being pivoted inward and inclined toward the apparatus body 12 (in the direction of arrow D in FIG. 2). The support shaft 53 of the conveyor belt unit 52 is disposed at a position different from that of the support shaft 51 of the cover 50. The support shaft 53 of the conveyor belt unit 52 is disposed in a corner portion, at the cover 50 side, of the conveyor belt unit 52 and is axially supported at a position further toward the cover 50 side than the center of gravity of the conveyor belt unit 52.

In FIG. 2, the conveyor belt unit 52 indicated by the solid line represents the conveyor belt unit 52 before being pivoted, and the conveyor belt unit 52 indicated by the two-dot chain line represents the conveyor belt unit 52 after being pivoted and inclined.

The conveyor belt unit 52 includes the conveyor belt 26 at the apparatus 12 side (left side in FIG. 2). Another path surface 46B of the second conveyance path 46 is formed, and one roll of each of the two upper conveyance roll pairs 48 is disposed, in the cover 50 side of the conveyor belt unit 52 (right side in FIG. 2).

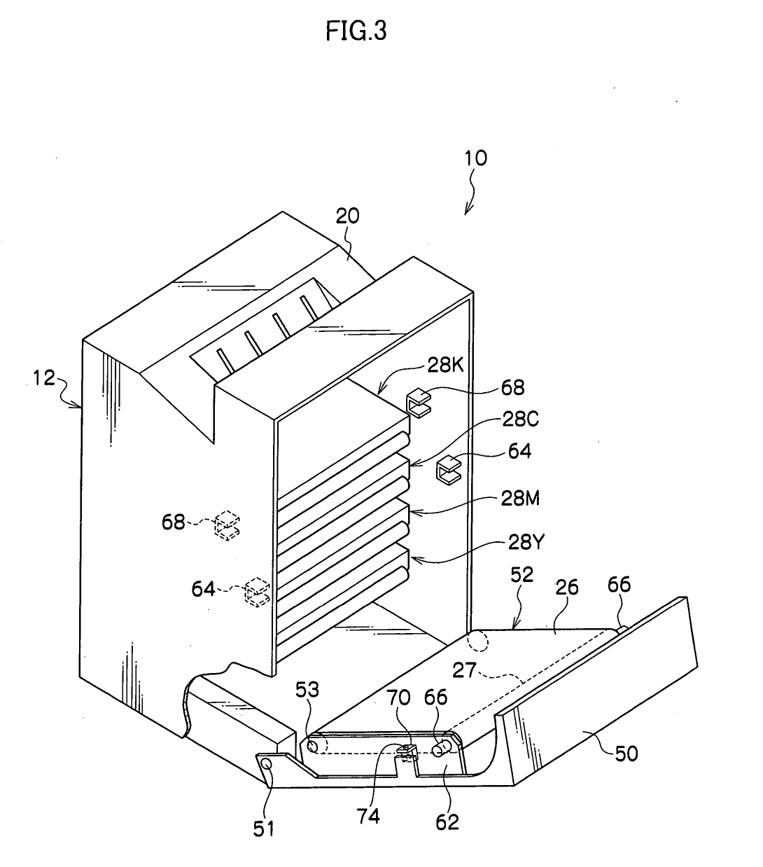

One roll of each of the two upper conveyance roll pairs 48, and the stretch rollers 27 and 29 that stretch the conveyor belt 26, are axially supported on a pair of side plates 62 of the conveyor belt unit 52, which side plates 62 are disposed on both axial-direction end portions (see FIG. 3). A stretch shaft 66 that supports the stretch roller 27 protrudes from both of the side plates 62. In FIGS. 2 to 4, only one of the side plates 62 is shown.

Generally U-shaped support members 64, which engage with both axial-direction end portions of the stretch shaft 66 and support the conveyor belt unit 52 in a state where the second conveyance path 46 has been opened up, are disposed in the apparatus body 12.

In a state where the stretch shaft 66 is engaged with the support members 64 and the conveyor belt unit 52 is supported, the end portion of the conveyor belt unit 52 abuts against the cover 50 and fulfills the role of a prop to prevent the cover 50 from pivoting in the closing direction.

In a state where the conveyor belt unit 52 and the cover 50 are closed, the stretch shaft 66 engages with fixing portions 68 and are positioned and fixed to the apparatus body 12.

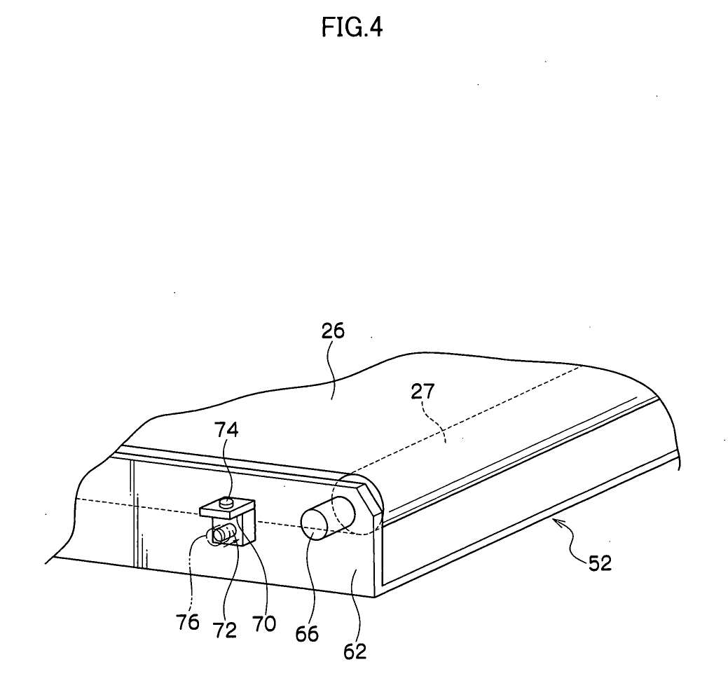

As shown in FIG. 4, handles 70 are disposed in the pair of side plates 62 at the free end sides of the conveyor belt unit 52. Protrusions 72 (locking portions) that lock the conveyor belt unit 52 to the cover 50, and release buttons 74 (release portions) that release this locked state, are disposed in the handles 70.

In the present embodiment, the protrusions 72 fit into recessed portions (locking portions) 76 formed in the cover 50, whereby the conveyor belt unit 52 is locked to the cover 50. By pressing the release buttons 74, the protrusions 72 withdraw such that the locked state is released. Because the release buttons 74 are disposed on the upper surfaces of the handles 70, the release buttons 74 are pressed when the handles 70 are gripped, and the locked state of the conveyor belt unit 52 is released in conjunction with the gripping of the handles 70.

Next, the action of the present embodiment will be described.

When a paper jam occurs in the first conveyance path 22, the cover 50 is pivoted with respect to the apparatus body 12 and reclined outward. Thus, the conveyor belt unit 52 pivots integrally with the cover 50 such that the first conveyance path 22 can be opened up to remove the jammed paper P.

In the present embodiment, because the conveyor belt unit 52 is axially supported on the cover 50, the first conveyance path 22 can be opened up with the single action of pivoting the cover 50.

The paper P, on which an image is to be formed, is conveyed on the first conveyance path 22. Thus, the potential for the paper P to become jammed in the first conveyance path 22 is high because the first conveyance path 22 has a higher frequency of use than that of the second conveyance path 46, through which the paper P on which an image has been formed on one side is passed. However, because the first conveyance path 22 can be opened up with a single action, its operability is good and it is easy to access.

When it is necessary to replace any of the process cartridges 28Y, 28M, 28C or 28K, the cover 50 is pivoted in the same manner integrally with the conveyor belt unit 52, such that the horizontal direction of the process cartridges 28Y, 28M, 28C and 28K is opened up. Thus, any of the process cartridges 28Y, 28M, 28C or 28K can be removed and replaced.

When a paper jam occurs in the second conveyance path 46, the cover 50 is pivoted integrally with the conveyor belt unit 52 to open up the first conveyance path 22. Thereafter, the handles 70 in the free end sides of the conveyor belt unit 52 are gripped and the release buttons 74 are pressed, whereby the locked state of the conveyor belt unit 52 to the cover 50 is released. After the locked state has been released, the conveyor belt unit 52 is pivoted toward the apparatus body 12 with respect to the cover 50 while gripping the handles 70, and the stretch shaft 66 of the conveyor belt 26 is caused to engage with the support members 64.

The operation of releasing the locked state of the conveyor belt unit 52 to the cover 50 is done in conjunction with the operation of gripping the handles 70. Thus, it is not necessary to shift the handles 70, and the operability is good. Also, because the handles 70 are in the free end sides of the conveyor belt unit 52, they are easy to grip and their operability is good.

Also, because the support shaft 53 of the conveyor belt unit 52 is disposed in the corner portion, at the cover 50 side, of the conveyor belt unit 52, the conveyor belt unit 52 inclines toward the support members 64 due to its own weight and is supported in an inclined state. For that reason, the paper P jammed in the second conveyance path 46 can be removed without having to manually support the conveyor belt unit 52.

In a state where the stretch shaft 66 is engaged with the support members 64, it fulfills the role of a prop such that the cover 50 cannot be closed. For that reason, the cover 50 cannot be accidentally pivoted in a state where the second conveyance path 46 is opened up (state where the conveyor belt unit 52 is not locked to the cover 50), and the constituent parts inside the apparatus are not damaged.

Also, because the stretch shaft 66 engages with the fixing portions 68 when the image forming apparatus 10 is running, it is not necessary to plurally dispose supported portions, and the number of parts can be reduced.

In the preceding embodiment, the cover 50 was configured to pivot around the support shaft 51 axially supported in the lower portion of the apparatus body 12. However, the cover of the present invention is not limited to this and may also be configured such that it is axially supported on a side portion of the apparatus body, pivot in the horizontal direction, and open horizontally.

In this case, the conveyor belt unit 52 can be supported by disposing two support members above and below one axial-direction end portion and disposing a supported portion (e.g., a shaft) that engages with the support members in one of the side plates 62.

Also, in the preceding embodiment, the stretch shaft 66 was configured to engage with the fixing portions 68 and the support members 64, but supported portions that engage with the fixing portions and the support members may also be plurally disposed.

Also, in the preceding embodiment, paper was used as the recording medium on which an image was to be formed, but the recording medium is not limited to paper. The present invention can also be applied to general industrially used image forming apparatus, such as apparatus that form an image on plastic film, metal plates or the like.

As described above, the present invention can be realized as an image forming apparatus that forms an image on a recording medium, the image forming apparatus including: an apparatus body; an image forming section disposed in the apparatus body; a conveyor belt that forms a first conveyance path between itself and the image forming section; a cover that is axially supported by a support shaft such that the cover is pivotable with respect to the apparatus body; and a conveyor belt unit that includes the conveyor belt, is axially supported such that the conveyor belt unit is pivotable with respect to the cover, and forms between itself and the cover a second conveyance path that returns the recording medium to the first conveyance path, wherein the first conveyance path can be opened up by pivoting the cover, with the conveyor belt unit being integrally pivoted with the cover, and the second conveyance path can be opened up by pivoting the conveyor belt unit in a state where the first conveyance path has been opened up.

The image forming apparatus may further includes a support member that is disposed in the apparatus body and supports a supported portion of the conveyor belt unit in a state where the second conveyance path has been opened up. Thus, the conveyor belt unit opening the second conveyance path can be supported by the support member, the removal of a jammed recording medium can be conducted with both hands, and the operability can be raised.

A support shaft of the conveyor belt unit may be disposed at a position different from that of the support shaft of the cover.

The support shaft of the conveyor belt unit may be disposed in a corner portion, at the cover side, of the conveyor belt unit.

One end portion of the conveyor belt unit may abut against the cover in a state where the supported portion is supported in the support member, such that the cover is prevented from pivoting.

A fixing portion that positions and fixes the conveyor belt unit when the image forming apparatus is running may be disposed in the apparatus body, and the supported portion may be configured to engage with the fixing portion.

The conveyor belt unit may be configured to include a stretch roller that stretches/conveys the conveyor belt, and the supported portion may be a stretch shaft that supports the stretch roller.

A handle that is gripped when pivoting the conveyor belt unit may be disposed in a free end side of the conveyor belt unit.

The conveyor belt unit may be configured to include a locking portion that locks with the cover and a release portion that releases the locked state of the locking portion, and the operation of releasing the release portion may be done in conjunction with the operation of gripping the handle.

The cover may be axially supported in a lower portion of the apparatus body and pivoted and reclined outward from the apparatus body to open up the first conveyance path, and the conveyor belt unit may be axially supported in a lower portion of the cover and pivoted and inclined toward the apparatus body to open up the second conveyance path.

Due to the above configuration, the operability of opening up the conveyance paths is good.

What is claimed is:

1. An image forming apparatus that forms an image on a recording medium, the image forming apparatus comprising:
an apparatus body;
an image forming section disposed in the apparatus body;
a conveyor belt that forms a first conveyance path between itself and the image forming section;
a cover that is axially supported by a support shaft such that the cover is pivotable with respect to the apparatus body; and
a conveyor belt unit that includes the conveyor belt, is axially supported such that the conveyor belt unit is pivotable with respect to the cover, and forms between itself and the cover a second conveyance path that returns the recording medium to the first conveyance path,
wherein the first conveyance path can be opened up by pivoting the cover, with the conveyor belt unit being integrally pivoted with the cover, and
the second conveyance path can be opened up by pivoting the conveyor belt unit in a state where the first conveyance path has been opened up.

2. The image forming apparatus of claim 1, further comprising a support member that is disposed in the apparatus body and supports a supported portion of the conveyor belt unit in a state where the second conveyance path has been opened up.

3. The image forming apparatus of claim 2, wherein a support shaft of the conveyor belt unit is disposed at a position different from that of the support shaft of the cover.

4. The image forming apparatus of claim 3, wherein the support shaft of the conveyor belt unit is disposed in a corner portion, at the cover side, of the conveyor belt unit.

5. The image forming apparatus of claim 2, wherein one end portion of the conveyor belt unit abuts against the cover in a state where the supported portion is supported in the support member, such that the cover is prevented from pivoting.

6. The image forming apparatus of claim 2, wherein a fixing portion that positions and fixes the conveyor belt unit when the image forming apparatus is running is disposed in the apparatus body, and the supported portion engages with the fixing portion.

7. The image forming apparatus of claim 2, wherein the conveyor belt unit includes a stretch roller that stretches/conveys the conveyor belt, and the supported portion is a stretch shaft that supports the stretch roller.

8. The image forming apparatus of claim 1, wherein a handle that is gripped when pivoting the conveyor belt unit is disposed in a free end side of the conveyor belt unit.

9. The image forming apparatus of claim 8, wherein the conveyor belt unit includes
a locking portion that locks with the cover, and
a release portion that releases the locked state of the locking portion,
and the operation of releasing the release portion is done in conjunction with the operation of gripping the handle.

10. The image forming apparatus of claim 1, wherein the cover is axially supported in a lower portion of the apparatus body and is pivoted and reclined outward from the apparatus body to open up the first conveyance path, and the conveyor belt unit is axially supported in a lower portion of the cover and is pivoted and inclined toward the apparatus body to open up the second conveyance path.
